(19) United States
(12) Patent Application Publication
(10) Pub. No.: US 2014/0263751 A1
(43) Pub. Date: Sep. 18, 2014

(54) Foaming Nozzle For Portable Pressure Washers

(71) Applicant: GENERAC POWER SYSTEMS, INC., Waukesha, WI (US)

(72) Inventors: Blake Zernicke, Janesville, WI (US); Mir Khan, Kenosha, WI (US); Greg Wischstadt, Wales, WI (US)

(73) Assignee: Generac Power Systems, Inc., Waukesha, WI (US)

(21) Appl. No.: 13/828,982

(22) Filed: Mar. 14, 2013

(51) Int. Cl. B05B 7/00

(52) U.S. Cl. CPC B05B 7/005
USPC 239/418; 29/890.143

(57) ABSTRACT

A foaming nozzle assembly and method of forming a foaming nozzle useable with pressure washing systems that includes a tube and a cover that cooperates with the tube. An interior surface of the tube defines a fluid path having by a first restriction, a second restriction, and an expansion chamber between the restrictions. An air path is defined between the cover and tube and fluidly connects the expansion chamber to atmosphere for introducing air to fluid associated with the fluid path. An atomizer is disposed downstream of the restrictions and expansion chamber and mixes the fluid and air to generate foam upon discharge of the mixture from the nozzle assembly.

### FIELD OF THE INVENTION

The present invention relates generally to pressure washer systems, and in particular, to a foaming nozzle assembly useable with such devices.

### BACKGROUND OF THE INVENTION

Pressure washers generally include a motor or engine that is operatively connected to a water pump. A high pressure hose connects a wand to a discharge side of the water pump. The wand commonly includes a pistol grip or the like that includes a trigger whose actuation effects discharge of a high-pressure water stream from the nozzle. Both the simplicity of operation and effectiveness associated with using such devices has made pressure washers a staple for various residential and commercial cleaning and surface preparation tasks. Understandably, many cleaning and surface preparation operations are best carried out with the use of extraneous cleaning or surface treatment agents. For instance, many deck and fence cleaning agents, automotive and/or fiberglass soaps, concrete cleaners, excreta, are commercially available and tailored to improve the efficiency of the particular cleaning operation. To better effectuate the cleaning or surface preparation operations, many power washers are configured for use with such soaps or agents.

Such agents are commonly introduced either via a high-pressure injector that introduces the agent to the pressurized water-stream downstream of the pump or a low-pressure injector that introduces the agent to the water-stream before feed water enters the pump. Regardless of the delivery methodology and the type of treatment agent, it is periodically desired to create a foaming action of the mixture upon delivery of the mixture to the surface intended to be treated. To generate the foaming action, air must be introduced to the agent and water mixture. Various attempts have been made to improve the foaming action associated with various power washing devices. Some such systems include extraneous systems such a compressed air sources that can be connected to the fluid stream generated by the nozzle associated with the wand associated with the pressure washing device. Still others having attempted to improve foaming action by providing supplemental nozzle assemblies that cooperate with either the wand or a nozzle associated therewith. Such systems commonly include a fairly tortuous fluid path associated with generating the mixing action of the water, treatment agent, and the air associated with generating the foaming action. Such systems are not however not without respective drawbacks.

Systems that rely on extraneous pressurized air sources are commonly more expensive to implement as a function of the additional hardware associated with generating the pressurized air flow. Such systems also increase the cost and complexity associated with the wand to facilitate the desired introduction of the air stream with the liquid fluid flow. Whether upstream or downstream of the wand nozzle assembly, such systems commonly require extraneous connection ports associated with communicating the air stream to the liquid fluid flow. Such systems also complicate operation of the systems in that users are required to monitor the operation of the various components associated with maintaining the desired air flow.

Although foaming nozzle assemblies resolve some of the complications associated with extraneous air systems, such nozzle assemblies are generally fairly complex and can include multiple fixed and/or moving parts associated with generating the desired communication of the liquid fluid and air flow through the nozzle assembly. Some such systems also require cooperation with a nozzle having a specific configuration and previously associated with the wand of the power washing system. Still other systems include auxiliary attachments that require direct contact between the attachment and the surface to be treated to generate the desired foaming action. Some such systems include a stringent multi-step connection methodology associated with engaging the components associated with the foaming activity to the underlying wand thereby detracting from the convenience of configuring the pressure washing device for other uses wherein foaming may not be desired.

Therefore, there is a need for a foaming nozzle assembly that is convenient to use and is operable with an underlying pressure or power washer without the need for extraneous systems to generate the desired foaming action.

### SUMMARY OF THE INVENTION

The present invention provides a foaming nozzle or foaming nozzle assembly and method of forming a foaming nozzle for use with pressure washing systems that overcomes one or more of the drawbacks mentioned above. A foaming nozzle assembly according to one aspect of the invention includes a tube and a cover that cooperates with the tube. An interior surface of the tube defines a fluid path having by a first restriction, a second restriction, and an expansion chamber between the restrictions. An air path is defined between the cover and tube and fluidly connects the expansion chamber to atmosphere for introducing air to fluid associated with the fluid path. An atomizer is disposed downstream of the restrictions and expansion chamber and mixes the fluid and air to generate foam upon discharge of the mixture from the nozzle assembly.

Another aspect to the invention that is usable with one or more of the features of the above aspect discloses a nozzle assembly for foaming a fluid flow generated by a power washer. The nozzle assembly includes an inner body having first end constructed to cooperate with a discharge end of a wand and second end that is longitudinally offset from the first end. A passage is formed through the inner body and a first restriction and a second restriction are formed in the passage and defined by the inner body. A first expansion chamber is formed between the first restriction and the second restriction and a second expansion chamber is formed downstream of the first expansion chamber and the second restriction. An outer body is disposed over a portion of the inner body and defines an outlet associated with fluid communicated through the inner body. At least one port is formed through the outer body and fluidly connects the first expansion chamber to atmosphere to allow air to enter a fluid stream between the first and second restrictions.

Another aspect of the invention that is useable with one or more of the above aspects discloses a foaming nozzle having an outer housing that has a discharge opening. An aeration port extends through the outer housing at a location that is offset from the discharge opening. A tube is disposed in the housing and overlaps the aeration port. The tube has a first end that faces a wand and a second end that is proximate the discharge opening of the outer housing. A fluid path is formed by an interior surface of the tube and an aeration path is formed between the outer housing and the tube. The aeration path fluidly connects the aeration port with the fluid path such that air that enters the aeration port travels in an opposite direction relative to a direction of flow through the fluid path.

A further aspect of the invention that is usable with one or more of the above aspects discloses a method of forming a foaming nozzle for use with a pressure washer. The method includes providing a tube that removably cooperates with a wand of a pressure washer. The method further defines that the tube has an internal fluid path that includes a first restriction, a second restriction, and an expansion chamber formed between the first and second restrictions. A cover is provided that overlies a portion of the tube such that the cover and the tube cooperate with one another to directly connect the expansion chamber to atmosphere for introducing air to the internal fluid path at a location that is between the first and second restrictions. An atomizer is disposed between the tube and the cover at a location that is downstream of the second restriction and improves the air and fluid stream mixing prior to discharge of the mixture from the foaming nozzle.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated of carrying out the invention.

In the drawings:

FIG. 1 is a perspective view of a portable engine powered pressure washing device equipped with a foaming nozzle assembly according to the present invention;

FIG. 2 is a detailed perspective view of the foaming nozzle assembly shown in FIG. 1;

FIG. 3 is an exploded view of the foaming nozzle assembly shown in FIG. 2 and removed from the wand; and

FIG. 4 is a cross-sectional view of the assembled foaming nozzle assembly shown in FIG. 2 and taken along a longitudinal centerline 4-4 of the assembly.

### DETAILED DESCRIPTION OF THE DRAWINGS

FIG. 1 shows a foaming nozzle assembly or a foaming nozzle 38 according to the present invention connected to a portable engine powered pressure washer 40. As shown in FIG. 1, pressure washer 40 includes an internal combustion engine 42 that is operationally connected to a pump 44. It is appreciated that the foaming nozzle 38 according to the present invention is usable with many underlying power or pressure washer systems, including those having an engine or a motor driven pump as well as less portable pressure washing systems. Those skilled in the art will readily appreciate the various alternative configurations of a power washing system usable with a foaming nozzle 38 according to the present application.

With respect to pressure washer 40, engine 42 can be directly or indirectly (via a power transmission system such as a belt or other flexible drive member) coupled to pump 44. When engine 42 directly cooperates with pump 44 without supplemental power transmission systems, pump 44 can be considered a direct drive pump. It is appreciated that there a number of methodologies associated with generating a desired fluid pressure output associated with use of pressure washer 40. One methodology includes providing a pressure output of the pump that is a function of the operational revolutions per minute (rpm) of the pump and which is directly correlated to the operation speed or revolutions per minute (rpm) of the engine crankshaft. The higher the rpm of the pump, the higher the pump output pressure—assuming other system variables to be constant. In such a confirmation, the input rpm of the pump is controlled by the engine rpm by means of controlling the engine throttle such that, variable pressures can be provided at the pump output pressure via manipulation of the engine throttle or engine speed. Alternatively, it is appreciated that the pressure output of pump 44 may be manipulated by a regulator as disclosed below. The variable pressure pump output in conjunction with an engine speed or pump pressure selector dial allows one pressure washer to act as though it were capable of providing several different fixed operating pressures.

As alluded to above, another methodology for manipulating the pump discharge pressure delivered to the wand includes providing a variable setting regulator or bypass valve assembly associated with operation of the pump. Such a configuration includes a valve assembly that is integral to the pump or disposed between pump 44 and a wand 46 for communicating the pressurized fluid flow to wand 46 connected to pump 44. As explained further below, the valve assembly includes a control or regulator associated with regulating the pressure flow communicated to the wand in a manner partially independent of engine operating speed. That is, such a regulator allows the delivery of fluid to wand 46 at variable pressures at or below a maximum output pressure associated with the available water source pressure and given operating conditions of engine 42.

Still referring to FIG. 1, wand 46 is connected to an output side of pump 44 via a hose 48. A trigger 50 is supported by wand 46 and is located at one end of wand 46. Foaming nozzle 38 is connected to a discharge end 52 of the wand 46. Discharge end 52 is commonly associated with the end of wand 46 that is opposite trigger 50. Discharge end 52 is constructed to removably cooperate with foaming nozzle 38 such that alternate nozzles can be engaged with the wand and which provide various spray patterns associated with the alternate nozzle assemblies and that may not include fluid flow foaming functionality. Pressure washer 40 preferably includes a chassis 54 having one or more wheels 56 and a handle 60 for improving the mobility of the unit to facilitate convenient transportation of pressure washer 40. It is appreciated that foaming nozzle 38 is usable with other less mobile pressure washing systems.

Pressure washer 40 can include a panel, bezel, or dashboard 61 that can include one or more instructional indicia 64 associated with the desired operation or intended use of pressure washer 40. Preferably, dashboard 61 includes one or more indicia that explain, either textually or pictographically, proper operation of pressure washer 40. Preferably, dashboard 60 includes one or more receptacles or mounting portions 66 associated with supporting replaceable or interchangeable tips or nozzles 72, 74, 76, 78, 80 associated with the desired use of pressure washer 40. As is readily understood, nozzles 72-80 are configured to interchangeably cooperate with the discharge end 52 of wand 46 so as to replace foaming nozzle 38 for non-foaming operations. Alternatively, it is appreciated that one more of nozzles 72, 74, 76, 78, 80 could be adjustable such that the discrete nozzles could provide more than one desired spray pattern.

It is further appreciated that wand 46 or pressure washer 40 include a treatment agent introduction system 104 for introducing a cleaning or treatment agent to the fluid flow delivered to wand 46 via hose 48. It is appreciated that agent introduction system 104 could be configured to introduce such a treatment agent to the feed water stream at a low pressure or a high pressure side of pump 44, prior to delivery of the operating fluid to wand 46, or immediately prior to the introduction of the operating fluid stream to foaming nozzle 38 at discharge end 52 of wand 46. It is further appreciated that although agent introduction system 104 is shown as being supported proximate engine 42 and pump 44 associated with chassis 54, agent introduction system 104 could be associated with hose 48 and/or supported and/or integrated with wand 46. Regardless of the specific location of agent introduction system 104, each such configuration allows introduction of the treatment agent to the water stream at a location that is upstream of foaming nozzle 38—relative to the operating direction of the fluid stream, such that the fluid stream introduced to foaming nozzle 38 is a mixture of treatment agent and the pressurized water stream.

FIG. 2 is a detailed perspective view of foaming nozzle 38 engaged with discharge end 52 of wand 46. A collar 84 is disposed at discharge end 52 of wand 46. Collar 84 preferably rotatably cooperates with a tube 86 of wand 46 and is constructed to removably cooperate with foaming nozzle 38. Collar 84 includes an outer radial surface 88 that is constructed to cooperate with the tool and/or be gripped by an operator to facilitate relative rotation of collar 84 relative to foaming nozzle 38. When fully engaged, collar 84 provides a sealed interaction between foaming nozzle 38 and tube 86 of wand 46 such that, during operation of pressure washer 40, fluid carried in wand tube 86 is directed through foaming nozzle 38 prior to discharge of the fluid flow from foaming nozzle 38. It is further appreciated that the selectively severable connection between foaming nozzle 38 and wand 46 could be provided in a quick-connect configuration wherein axial displacement of a respective nozzle relative to wand 46 and a slidable collar facilitates the sealed connection of the respective nozzle to the wand 46.

Referring to FIGS. 2 and 3, foaming nozzle 38 includes an outer body, outer housing, or cover 90 that cooperates with an inner body or tube 92. Cover 90 includes a first end 94 and the second end 96 that are disposed at opposite longitudinal ends, indicated by longitudinal centerline 98, of cover 90. First end 94 of cover 90 removably cooperates with a first threaded portion 100 of tube 92. An outer radial surface 102 of cover 90 is contoured to cooperate with a tool or otherwise configured to be gripped by the operator to effectuate the desired rotation between cover 90 and tube 92. A discharge opening 104 is formed to cover 90 proximate second end 96 and provides egress of the fluid flow directed through foaming nozzle 38 to generate foam as explained further below. Discharge opening 104 is preferably positioned proximate axis 98. Second end 96 includes a recess 106 that intersects discharge opening 104. Recess 106 assists in facilitating the desired directional discharge of the foaming fluid stream from foaming nozzle 38.

Cover 90 includes one or more openings, passages, aeration ports or simply ports 108 that extend in a radial direction through cover 90 relative to axis 98. Preferably, aeration ports 108 are spaced radially along the circumference of cover 90 between first end 94 and second end 96 of cover 90. Preferably, aeration ports 108 are nearer second end 96 than first end 94. As explained further below, aeration ports 108 form a portion of an air path associated with connecting the fluid stream directed through foaming nozzle 38 to atmosphere and facilitate the introduction of air into the fluid stream prior to discharge of a mixed air and fluid stream at discharge opening 104.

FIG. 3 shows cover 90 and tube 92 of foaming nozzle 38 separated from one another and exploded along axis 98. As explained above, tube 92 includes a second threaded portion 110 that is offset from threaded portion 100 by a rib 112. Second threaded portion 110 facilitates the removable cooperation of foaming nozzle 38 with collar 84 of wand 46. Second threaded portion 110 is proximate a first end 114 of tube 92. Threaded portion 110 of tube 92 could be contoured to cooperate with a quick connector for use with wands constructed in such a manner. A second end 116 of tube 92, relative to longitudinal axis 98, is shaped to slidably cooperate with an interior cavity 118 of cover 90 such that cover 90 can rotatably cooperate with first threaded portion 100 of tube 92.

A radially outward surface 120 of tube 92 between first end 114 and second end 116 includes a first channel or groove 124 that is nearer threaded portion 100 and a second channel or groove 126 that is nearer second end 116. A first and a second gasket or seal 128, 130 are shaped to be received in grooves 124, 126 and to extend beyond surface 120. Seals 128, 130 are shaped to slidably and sealingly cooperate with an interior facing surface 127 of cover 90 when foaming nozzle 38 is assembled. As explained further below, such a construction mitigates the fluid flow passing through tube 92 from entering any cavities or passages formed between the outer surface of tube 92 and the inner facing surface 127 of cover 90.

A portion 132 of tube 92 between groove 124 and groove 126 includes a number of slots, cavities, channels, or recesses 136 and a number of ribs or ridges 138 that are positioned between adjacent recesses 136. Recesses 136 and ridges 138 preferably extend in a longitudinal direction that is generally aligned with axis 98 and are preferably spaced about the circumference of portion 132 of tube 92. An opening or slot 140 is associated with each recess 136 and extends in a radial direction through tube 92. Slots 140 provide a fluid connection between an interior passage or fluid path 142 of tube 92 and outer surface 120 of tube 92. However, as explained below, cover 90 and tube 92 are constructed to cooperate with one another and manipulate the fluid flow directed therethrough to allow air to infiltrate the fluid flow associated with fluid path 142 while preventing the egress of fluid flow via ports 108. When foaming nozzle 38 is assembled, slots 140 and recesses 136 of tube 92 are oriented to be generally rotationally aligned with a respective aeration port 108 associated with cover 90.

FIG. 4 shows a cross-sectional view of foaming nozzle 38 when assembled. An interior surface 146 of tube 92 is shaped to manipulate a fluid stream 148 as the fluid stream progresses in an operating or downstream flow direction, indicated by arrow 150, through foaming nozzle 38. As mentioned above, fluid stream 148 is primarily water but includes a treatment agent, such as soap, that is mixed with the water prior to the introduction of fluid stream 148 at inlet end 114 of tube 92. Interior surface 146 of tube 92 is shaped to define a first restriction 152, a second restriction 154, and a first expansion chamber 156 that is disposed between first restriction 152 and second restriction 154. A second expansion chamber 158 is downstream of first restriction 152, second restriction 154, and first expansion chamber 156 relative to fluid flow direction 150.

A portion 160 of first expansion chamber 156 is oriented upstream, or in a direction inapposite to the working fluid flow direction, indicated by arrow 162, relative to an outlet opening 164 of first restriction 152. Slots 140 of tube 92 are fluidly connected to portion 160 of first expansion chamber 156. An aeration passage 166 extends in a longitudinal direction, indicated by axis 98, between each of slots 140 of tube 92 and ports 108 of cover 90. As explained further below, air traveling through aeration passages 166 travels in upstream direction 162, or a direction opposite to the fluid flow direction 150 within tube 92, from atmosphere around foaming nozzle 38. The air communicated along aeration passages 166 enters the agent and water fluid stream as the fluid flow progresses through tube 92 in downstream flow direction 150 from first expansion chamber 156 and toward second restriction 154. As explained further below, the downstream manipulation of the combined fluid and air solution generates foam upon egress of the mixture at discharge opening 104 of cover 90.

An atomizer 168 is disposed between second end 116 of tube 92 and discharge opening 104 of cover 90. Atomizer 168 is preferably constructed of a mesh wire material or is otherwise constructed to fully mix the fluid and air flow mixture introduced thereto from second expansion chamber 158 of tube 92. The pressure and physical mixing of the constituents associated with the flow discharged from second end 116 of tube 92 generates foam 170 during use of foaming nozzle 38.

During operation of pressure washer 40, a water and treatment agent mixture is introduced to tube 92. This fluid mixture is pressurized as it passes through first restriction 152. Upon egress of the fluid mixture at an outlet 164 associated with first restriction 152, an increase in volume associated with first expansion chamber 156 creates a vacuum pressure that allows atmospheric air to be drawn through port 108 of cover 90, travel upstream along aeration passage 166 between tube 92 and cover 90, and be introduced to the fluid flow via slots 140 associated with tube 92. The water, agent, and air mixture progresses downstream 150 along second restriction 154 gradually increasing the pressure of the fluid flow prior to entry of the fluid and air mixture into second expansion chamber 158.

Second restriction 154 and expansion chamber 158 of tube 92 provide preliminary mixing of the water, agent, and air carried on the fluid stream downstream of expansion chamber 156 prior to introduction of the mixture to atomizer 168. Atomizer 168 provides further mixing of the water, agent, and air prior to discharge of the air infused mixture at discharge opening 104 of cover 90 as foam 170. Foaming nozzle 38 provides a compact and eloquent foaming nozzle assembly that includes no moving parts and which is convenient to service. Foaming nozzle 38 provides a nozzle assembly that cooperates with pressure washer 40 in a manner that does not detract from the functionality of the pressure washer 40 or use of the pressure washer for foaming and other non-foaming applications.

Many changes and modifications could be made to the invention without departing from the spirit thereof. The scope of these changes will become apparent from the appended claims.

1. A nozzle assembly for foaming a fluid flow generated by a power washer, the nozzle assembly comprising:
an inner body having first end constructed to cooperate with a discharge end of a wand and second end that is longitudinally offset from the first end;
a passage formed through the inner body;
a first restriction and a second restriction formed in the passage and defined by the inner body, the first restriction and the second restriction positioned to define 1) a first expansion chamber formed between the first restriction and the second restriction and 2) a second expansion chamber formed downstream of the first expansion chamber and the second restriction;
an outer body disposed over a portion of the inner body and defining an outlet associated with fluid communicated through the inner body; and
at least one port formed through the outer body and fluidly connecting the first expansion chamber to atmosphere to allow air to enter a fluid stream between the first and second restrictions.

2. The nozzle assembly of claim 1 further comprising an atomizer disposed between the inner body and the outlet of the outer body, the atomizer being configured to mix a flow of fluid that passes through the first restriction and air provided from the at least one port to create foam as the fluid flow discharges at the outlet.

3. The nozzle assembly of claim 1 wherein the outer body further comprises a threaded portion that rotatably cooperates with a threaded portion of the inner body to translate the outer body longitudinally over the portion of the inner body.

4. The nozzle assembly of claim 1 further comprising a groove formed in one of the outer body and the inner body and a seal disposed in the groove and extending into contact with the other of the outer body and the inner body.

5. The nozzle assembly of claim 4 further comprising another groove formed in one of the outer body and the inner body and another seal disposed in the another groove and extending into contact with the other of the outer body and the inner body.

6. The nozzle assembly of claim 5 wherein each of the grooves is formed in a radially oriented exterior surface of the inner body and the seals are disposed on opposite longitudinal sides of the at least one port.

7. The nozzle assembly of claim 1 further comprising at least one opening formed through the inner body, the at least one opening being oriented nearer the first end of the inner body than the at least one port formed through the outer body when the outer body is fully engaged with the inner body.

8. A foaming nozzle comprising:
an outer housing having a discharge opening;
an aeration port extending through the outer housing at a location offset from the discharge opening;
a tube disposed in the housing and overlapping the aeration port, the tube having a first end that faces a wand and a second end proximate the discharge opening of the outer housing, an interior surface of the tube defining a fluid path through the tube; and
the outer housing and the tube cooperating with one another to define an aeration path formed between the outer housing and the tube, the aeration path fluidly connecting the aeration port with the fluid path such that air that enters the aeration port travels in an opposite direction relative to a direction of flow through the fluid path.

9. The foaming nozzle of claim 8 further comprising an atomizer disposed in the outer housing between the outer housing and the second end of the tube.

10. The foaming nozzle of claim 9 wherein the atomizer is formed of a mesh material.

11. The foaming nozzle of claim 8 wherein the aeration port is further defined as a plurality of openings that pass through and are positioned radially about the outer housing.

12. The foaming nozzle of claim 8 wherein the tube defines a first restriction, a second restriction, and an expansion chamber formed between the first and second restrictions.

13. The foaming nozzle of claim 12 further comprising a slot formed through the tube that fluidly connects the expansion chamber to the aeration path.

14. The foaming nozzle of claim 13 wherein the slot is further defined as a plurality of slots formed through the tube and that are radially spaced from one another.

15. A method of forming a foaming nozzle for use with a pressure washer, the method comprising:
providing a tube that removably cooperates with a wand of a pressure washer, the tube having an internal fluid path that includes a first restriction, a second restriction, and an expansion chamber formed between the first and second restrictions;
providing a cover that overlies a portion of the tube, the cover and tube cooperating with one another to directly connect the expansion chamber to atmosphere for introducing air to the internal fluid path at a location between the first and second restrictions;
disposing an atomized between the tube and the cover at a location downstream of the second restriction.

16. The method of claim 15 further comprising forming a plurality of the cover openings through the cover at a location associated with increasing pressure of a fluid flow through the internal fluid path caused by the second restriction.

17. The method of claim 16 further comprising spacing the plurality of cover openings about a radius of the cover.

18. The method of claim 16 further comprising forming a plurality of tube openings that extend radially through the tube between the expansion chamber and an air passage defined by an inner radial surface of the cover and an outer radial surface of the cover.

19. The method of claim 18 further comprising positioning the plurality of tube openings relative to the plurality of cover openings such that air moves through the air passage in an opposite direction relative to a direction of fluid flow through the internal fluid path.

20. The method of claim 15 further comprising providing a first seal and a second seal between the tube and cover at locations near the first restriction and the second restriction, respectively.
